(19) United States
(12) Patent Application Publication
(10) Pub. No.: US 2015/0153174 A1
(43) Pub. Date: Jun. 4, 2015

(54) APPARATUS FOR DRIVING GYRO SENSOR AND CONTROL METHOD THEREOF

(71) Applicant: SAMSUNG ELECTRO-MECHANICS CO., LTD., Suwon-si (KR)

(72) Inventors: Sung Tae KIM, Suwon-si (KR); Young Kil CHOI, Suwon-si (KR); Jun Kyung NA, Suwon-si (KR); Seung Chul PYO, Suwon-si (KR); Chang Hyun KIM, Suwon-si (KR)

(21) Appl. No.: 14/558,639

(22) Filed: Dec. 2, 2014

(30) Foreign Application Priority Data
Dec. 4, 2013 (KR) 10-2013-0149766

(51) Int. Cl. G01C 19/5705

(52) U.S. Cl. CPC G01C 19/5705

(57) ABSTRACT

An apparatus for driving a gyro sensor includes a gyro sensor, an analog circuit, a signal converter, and a digital automatic gain controller. The gyro sensor includes at least one driving mass. The analog circuit detects an amplitude value or a phase value of resonance of the driving mass from first and second driving displacement signals output from the gyro sensor. The signal converter converts the amplitude value or the phase value into a digital value. The digital automatic gain controller outputs a control gain for controlling a signal driving resonance of the driving mass based on a selected one of a phase or amplitude of resonance of the driving mass, so that a selected one of the amplitude value and the phase value input from the signal converter is converged to a preset targeted value.

### CROSS REFERENCE TO RELATED APPLICATION

This application claims the benefit of Korean Patent Application No. 10-2013-0149766, filed on Dec. 4, 2013, entitled “Apparatus For Driving Gyro Sensor And Control Method Thereof” which is hereby incorporated by reference in its entirety into this application.

### BACKGROUND OF THE INVENTION

1. Technical Field

The present invention relates to an apparatus for driving a gyro sensor and a control method thereof.

2. Description of the Related Art

Recently developed mobile devices which are being provided with inertial sensors (e.g., acceleration sensors, gyro sensors, terrestrial magnetism sensors, and the like) that measure inertial inputs applied from the outside. Among the various types of inertial sensors, the gyro sensor is a sensor which detects a rotating force acting on an object and enables the measurement of a corresponding angular velocity. The angular velocity may be calculated based on a formula for the Coriolis force “F=2 mΩV”, in which m represents a mass of a sensor mass, Ω represents an angular velocity to be measured, and V represents a motion velocity of the sensor mass.

FIG. 1 is a schematic diagram illustrating a principle of detecting an angular velocity of a gyro sensor. When the sensor mass is resonated in an X direction, and a rotating force is applied having an axis of rotation aligned with the Z direction, the Coriolis force is generated in a Y direction. The gyro sensor converts a signal resulting from the effect of the inertial/Coriolis force on the sensor mass into an electrical signal. In turn, a control circuit of the gyro sensor determines, based on the converted signal, the angular velocity using a predetermined signal processing process. In this case, to stably detect the inertial input/force, it is very important to resonate the mass of the gyro sensor at all times.

Further, in order to stably resonate the mass of the gyro sensor, it is first of all important to control the amplitude and the phase of mass resonance. Control of the amplitude of the mass resonance involves ensuring that the mass resonates at the predetermined amplitude at all times. Control of the phase involves maintaining a phase difference between the mass resonation and the signal generated from the control circuit so as to resonate the mass.

Therefore, as described in Japanese Patent Document No. JP 2004-212111, a phase or amplitude control method of a mass resonance for a gyro sensor involves manually setting a control value or generally using an analog circuit (phase locked loop or feedback loop). However, after the initial setting, the fluctuation of the mass due to the deformation of the MEMS structure may not be corrected by real-time monitoring. Additionally, the control method using the analog circuit relatively increases the circuit size and increases current consumption, and the like.

### PRIOR ART DOCUMENT

### Patent Document

(Patent Document 1) JP2004-2211 A

### SUMMARY OF THE INVENTION

The present invention has been made in an effort to provide a method for driving a gyro sensor and a control method thereof capable of reducing a size and current consumption of the overall driving circuit, and performing a control with high precision by using a digital automatic gain controller and a proportional integral control (PID control) to stably control a phase and amplitude of driving mass resonance for the gyro sensor.

According to a preferred embodiment of the present invention, there is provided an apparatus for driving a gyro sensor, including: a gyro sensor including at least one driving mass; an analog circuit detecting an amplitude value or a phase value of resonance of the driving mass from first and second driving displacement signals output from the gyro sensor; a signal converter converting the amplitude value or the phase value into a digital value; and a digital automatic gain controller outputting a control gain for controlling a signal driving resonance of the driving mass based on a selected one of a phase or amplitude of resonance of the driving mass, so that a selected one of the amplitude value and the phase value input from the signal converter is converged to a preset targeted value.

The digital automatic gain controller may transmit the control gain for controlling the phase or the amplitude of resonance of the driving mass to the analog circuit.

The analog circuit may generate through a first comparator a first clock signal which is phase-synchronized with the first driving displacement signal and generate through a second comparator a second clock signal having a phase that is 90° earlier than a phase of the first driving displacement signal.

The analog circuit may select the first clock signal or the second clock signal depending on whether the amplitude value or the phase value of the driving mass resonance is to be converged to the preset targeted value.

The analog circuit may detect the amplitude value of resonance of the driving mass by mixing the first driving displacement signal and the first clock signal when the first clock signal is selected, and detect the phase value of resonance of the driving mass by mixing the first driving displacement signal and the second clock signal when the second clock signal is selected.

The analog circuit may include a low pass filter (LPF) circuit which removes noise from the detected phase value or the detected amplitude value of resonance of the driving mass.

The signal converter may be an analog to digital converter.

The digital automatic gain controller may receive a data signal including selected samples of one of the amplitude value and the phase value of resonance of the driving mass from the analog circuit, wherein the samples are selected based on a preset rate coefficient that is determined according to a response speed of the amplitude or phase of the driving mass to changes in the control gain.

The digital automatic gain controller may include a filter module which removes noise from the selected samples of the amplitude value or the phase value of resonance of the driving mass.

The digital automatic gain controller may generate a lock flag signal operative to cause a value of the control gain associated with the selected one of the amplitude value and the phase value being converged to the targeted value being held, and operative to cause an operation to be performed on the control gain to adjust the value of the other one of the amplitude value and the phase value.

The analog circuit may include: a charge amplifier converting the signals output from the gyro sensor into voltage signals and amplifying and outputting the first and second driving displacement signals based on the signals output from the gyro sensor; a driving displacement signal processing module generating a first clock signal which is phase-synchronized with the first driving displacement signal and a second clock signal having a phase that is 90° earlier than a phase of the first driving displacement signal by using the first and second driving displacement signals, and detecting the amplitude value or the phase value of resonance of the driving mass by mixing the first driving displacement signal with the first clock signal or the second clock signal; and a driving circuit module using the second clock signal to generate a driving signal to be applied to the gyro sensor.

The driving displacement signal processing module may include: a first clock generation circuit using a comparator and the first and second driving displacement signals to generate the first clock signal that is phase-synchronized with the first driving displacement signal; a phase conversion circuit shifting the phase of the first driving displacement signal by 90°; a second clock generation circuit using a comparator, a signal obtained by shifting the phase of the first driving displacement signal by 90°, and a preset reference voltage to generate the second clock signal; a clock selection circuit selecting the first clock signal or the second clock signal depending on a selection signal received from the digital automatic gain controller; a synchronous detection circuit detecting the amplitude value or the phase value of resonance of the driving mass by mixing the first clock signal or the second clock signal and the first driving displacement signal; a filter circuit filtering the detected amplitude value or phase value of resonance of the driving mass by removing noise from the amplitude value or the phase value of resonance of the driving mass detected by the synchronous detection circuit; and an analog multiplexer transmitting one of the filtered amplitude value and the filtered phase value of resonance of the driving mass to the digital automatic gain controller.

The driving circuit module may include: a signal conversion circuit converting the control gain for the amplitude of resonance of the driving mass received from the digital automatic gain controller and used to determine an amplitude of the driving signal to be applied to the gyro sensor; and a driving signal generation module using the amplitude of the driving signal and the second clock signal to generate the driving signal to be applied to the gyro sensor.

The digital automatic gain controller may include: a data selection module receiving data for the amplitude value or the phase value of resonance of the driving mass from the signal converter, and selectively outputting the received data depending on a rate coefficient set in consideration of a response speed of the driving mass to changes in the control gain applied to the driving mass; a gain control module generating the control gain for the phase or the amplitude so that the amplitude value or the phase value of resonance of the driving mass reaches the preset targeted value; and a data processing control module controlling the gain control module so as to converge one of the amplitude and the phase of resonance of the driving mass to the preset targeted value, and controlling the gain control module so as to converge another one of the amplitude and the phase of the resonance of the driving mass.

The digital automatic gain controller may further include a filter which is disposed between the data selection module and the gain control module and removes noise from the amplitude value or the phase value of resonance of the driving mass output by the data selection module.

The gain control module may transmit to the data processing control module a lock flag signal operative to cause a value of the control gain associated with the selected one of the amplitude value and the phase value being converged to the targeted value to be held when any one of the phase and the amplitude of the driving mass resonance is converged to the preset targeted value.

The data processing control module may, in response to receiving the lock flag signal, control the clock selection circuit to transmit only the data for the signal which is not converged to the preset targeted value in the phase or the amplitude of the driving mass resonance to the gain control module.

The data processing control module may transmit a select signal to the clock selection circuit to cause the clock selection circuit to select a particular one of the first clock signal and the second clock signal.

According to another preferred embodiment of the present invention, there is provided a control method of an apparatus for driving a gyro sensor, including: detecting, by an analog circuit, an amplitude value or a phase value of resonance of a driving mass of the gyro sensor from first and second driving displacement signals output from the gyro sensor; converting, by a signal converter, the detected amplitude value or the detected phase value into a digital value; and performing, by a digital automatic gain controller, an operation on a control gain for adjusting a phase or an amplitude of resonance of the driving mass so that one of the amplitude value and the phase value received from the signal converter converges to a preset targeted value.

The detecting, by the analog circuit, of the amplitude value or the phase value of resonance of the driving mass may include: converting, by a charge amplifier, the signals output from the gyro sensor into voltage signals and amplifying the voltage signals to output the first and second driving displacement signals; using, by a driving displacement signal processing module, the first and second driving displacement signals to generate first and second clock signals and detecting the amplitude value or the phase value of resonance of the driving mass by mixing the first driving displacement signal and the first clock signal or the second clock signal; and using, by a driving circuit module, the second clock signal to generate a driving signal to be applied to the gyro sensor.

The detecting, by the driving displacement signal processing module, of the amplitude value or the phase value of resonance of the driving mass may include: comparing, in a first clock generation circuit, the first and second driving displacement signals to generate the first clock signal that is phase-synchronized with the first driving displacement signal; shifting, by a phase conversion circuit, a phase of the first driving displacement signal by 90°; comparing, using a second clock generation circuit, a signal obtained by shifting the phase of the first driving displacement signal by 90° and a preset reference voltage to generate the second clock signal; selecting, by a clock selection circuit, the first clock signal or the second clock signal depending on whether the amplitude value or the phase value of resonance of the driving mass is converged to the preset targeted value in the digital automatic gain controller; detecting, by a synchronous detection circuit, the amplitude value or the phase value of resonance of the driving mass by mixing the first clock signal or the second clock signal and the first driving displacement signal; filtering, by a low pass filter circuit, the amplitude value or the phase value of the driving mass resonance by removing noise from the amplitude value or the phase value of resonance of the driving mass detected by the synchronous detection circuit; and transmitting, by an analog multiplexer, the amplitude value or the phase value of resonance of the driving mass to the digital automatic gain controller.

The generating, by the driving circuit module, of the driving signal may include: converting, by a signal converter, the control gain for the amplitude of the driving mass resonance that is received from the digital automatic gain controller to determine an amplitude of the driving signal to be applied to the gyro sensor; and using, by a driving signal generation module, the converted amplitude of the driving signal and the second clock signal to generate the driving signal to be applied to the gyro sensor.

The performing, by the digital automatic gain controller, of the operation on the control gain for adjusting the phase or the amplitude of resonance of the driving mass may include: outputting, by a data selection module, selected samples of data for the amplitude value or the phase value of resonance of the driving mass wherein the samples are selected depending on a preset rate coefficient that is set in consideration of a response speed of the driving mass to changes in control gain applied thereto; performing, by a gain control module, the operation to generate the control gain for the phase or the amplitude so that the amplitude value or the phase value of resonance of the driving mass reaches the preset targeted value; and controlling, by a data processing control module, the gain control module to converge one of the amplitude and the phase of resonance of the driving mass to the preset targeted value, and controlling the gain control module so as to converge another one of the amplitude and the phase of resonance of the driving mass.

The controlling, by a data processing control module, of the gain control module to perform the operation of the control gain for the amplitude and the phase of resonance of the driving mass may include: transmitting, by the gain control module to the data processing control module, a lock flag signal operative to cause a value of the control gain associated with the selected one of the amplitude value and the phase value being converged to the targeted value to be held when any one of the phase and the amplitude of the driving mass resonance is converged to the preset targeted value; and controlling, by the data processing control module in response to receiving the lock flag signal, the clock selection circuit to transmit only the data for the signal which is not converged to the preset targeted value in the phase or the amplitude of the driving mass resonance to the gain control module.

The data processing control module may transmit a select signal to the clock selection circuit to select any one of the first clock signal and the second clock signal.

According to another preferred embodiment of the present invention, there is provided a gyro sensor including: a driving mass mounted in the gyro sensor so as to resonate in response to a driving signal; and a controller configured to sense an amplitude and a phase of resonance of the driving mass, and to sequentially adjust during sequential time periods a gain controlling the driving signal applied to the driving mass based on the amplitude of resonance of the driving mass and a gain controlling the driving signal based on the phase of resonance of the driving mass.

The controller may be configured to: during a first time period, adjust the gain controlling the driving signal applied to the driving mass based on a first one of the amplitude and the phase of resonance of the driving mass so as to cause the first one of the amplitude and the phase of resonance of the driving mass to converge to a preset targeted value; and upon determining that the first one of the amplitude and the phase of resonance of the driving mass is converged to the preset targeted value, adjust the gain controlling the driving signal applied to the driving mass based on another one of the amplitude and the phase of resonance of the driving mass during a second time period.

The controller may include: an analog circuit producing amplitude value and phase value signals respectively indicative of the amplitude and the phase of resonance of the driving mass. The analog circuit may include: a charge amplifier sensing changes in charge amounts generated in first and second driving displacement electrodes of the gyro sensor, and outputting first and second driving displacement signals based on the sensed changes; a driving displacement signal processing module generating, based on the first and second driving displacement signals, a first clock signal that is phase-synchronized with the first driving displacement signal and a second clock signal that is 90° out of phase with the first clock signal, wherein the driving displacement signal processing module further generates an output signal that is indicative of the first one of the amplitude and the phase of resonance of the driving mass during the first time period and that is indicative of the other one of the amplitude and the phase of resonance of the driving mass during the second time period; and a driving circuit module generating the driving signal applied to the driving mass so as to resonate the driving mass. The controller may further include a digital automatic gain controller receiving the output signal generated by the driving displacement signal processing module, and adjusting the gain controlling the driving signal applied by the driving circuit module to the driving mass based on the received output signal indicative of one of the amplitude and the phase of resonance of the driving mass.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a principle of detecting an angular velocity of a gyro sensor;

FIG. 2 is a block diagram illustrating an apparatus for driving a gyro sensor according to an exemplary embodiment of the present invention;

FIG. 3 is a detailed diagram illustrating an overall system for driving a gyro sensor according to the exemplary embodiment of the present invention;

FIG. 4 is a flow chart illustrating a control method used in an apparatus for driving a gyro sensor according to an exemplary embodiment of the present invention;

FIG. 5 is a block diagram illustrating a configuration of an analog circuit according to an exemplary embodiment of the present invention;

FIGS. 6A and 6B are block diagrams illustrating configurations of a module for processing a driving displacement signal according to an exemplary embodiment of the present invention;

FIG. 7 is a diagram for explaining a process of detecting a phase and an amplitude value of resonance of a driving mass in the module for processing a driving displacement signal according to the exemplary embodiment of the present invention;

FIG. 8 is a block diagram illustrating a configuration of a digital automatic gain controller according to an exemplary embodiment of the present invention;

FIG. 9 is a diagram illustrating a data processing process performed in a data selection module according to an exemplary embodiment of the present invention; and

FIG. 10 is a diagram illustrating a data processing process performed in a gain control module according to an exemplary embodiment of the present invention.

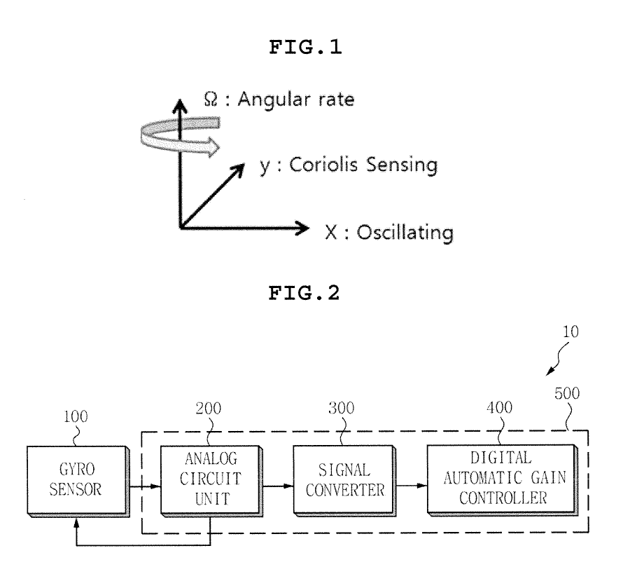

### DETAILED DESCRIPTION

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side,” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings. In this case, a driving displacement signal, and the like, may be represented by a voltage form or a current form.

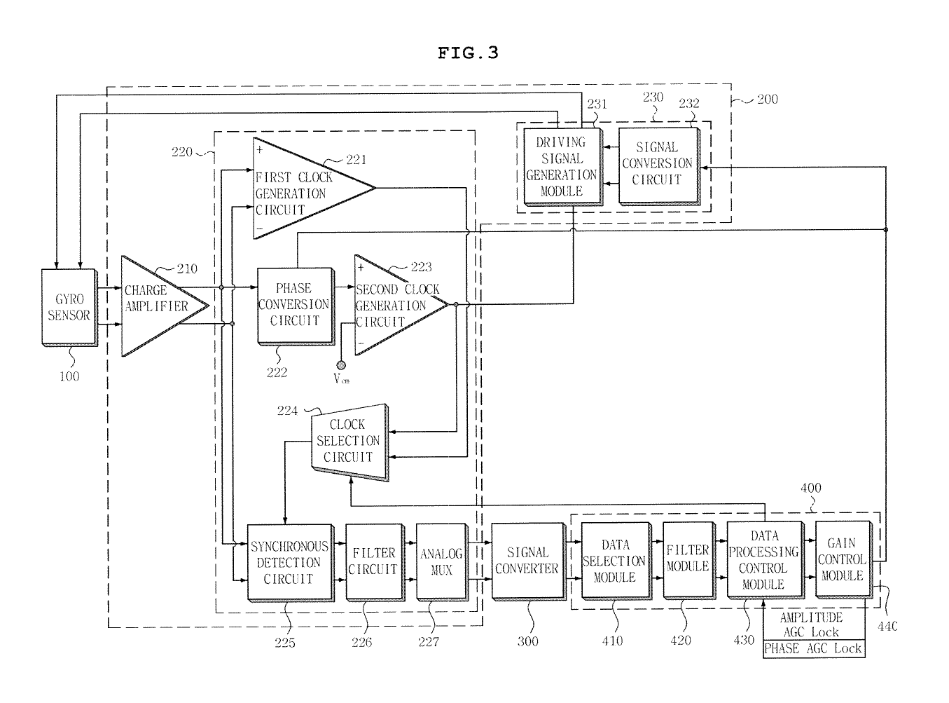

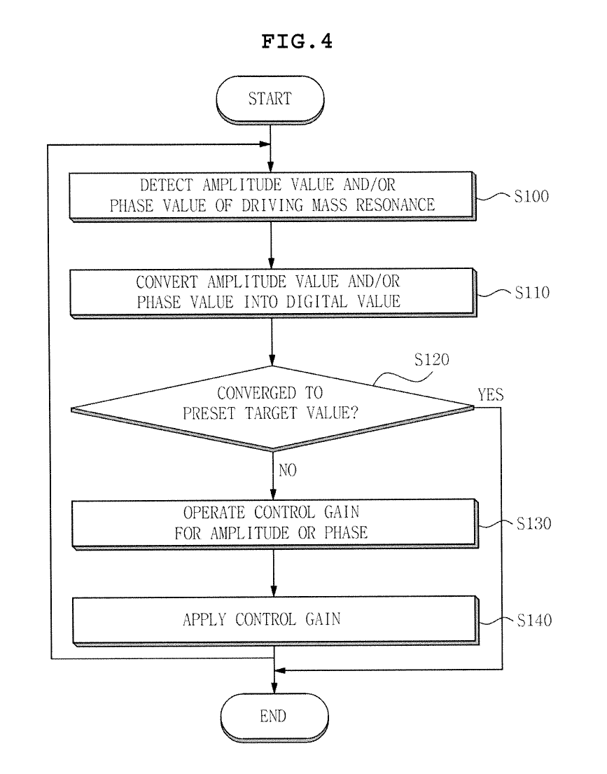

FIG. 2 is a block diagram illustrating an apparatus for driving a gyro sensor according to an exemplary embodiment of the present invention, FIG. 3 is a diagram illustrating the overall system of the apparatus for driving a gyro sensor according to the exemplary embodiment of the present invention, and FIG. 4 is a flow chart illustrating a control method of an apparatus for driving a gyro sensor according to an exemplary embodiment of the present invention.

As illustrated in FIG. 2, an apparatus 10 for driving a gyro sensor according to an exemplary embodiment of the present invention includes a gyro sensor 100, an analog circuit 200, a signal converter 300, and a digital automatic gain controller 400.

The gyro sensor 100 is a sensor which includes a driving mass (not illustrated). The gyro sensor 100 is configured to detect angular velocities in three axial directions. Meanwhile, a driving signal (e.g., a pulse wave such as a square pulse wave) applied to the gyro sensor 100 by the analog circuit 200 vibrates the driving mass, a driving displacement signal (e.g., a sine wave) is generated by the vibration, and the driving displacement signal is configured to include first and second driving displacement signals having a phase difference of 180° from each other.

Herein, in order for the driving signal to resonate the driving mass most efficiently, the phase difference between the driving signal and the driving displacement signal should be set to 90°. Under such conditions, when the driving mass is resonated, a motion of the driving mass is relatively large even when an amplitude of the driving signal is small; as a result, the driving displacement signal that is obtained from the motion of the driving mass has a large amplitude. To obtain a large signal output from the gyro sensor 100, it is advantageous to stably resonate the driving mass at all times.

The analog circuit 200 detects an amplitude value or a phase value of the driving mass resonance from the first and second driving displacement signals which are output from the gyro sensor 100. Specifically, a first clock signal which is phase-synchronized with the first driving displacement signal and a second clock signal having a phase 90° earlier than the phase of the first driving displacement signal are generated through comparators. As the amplitude value or the phase value of the driving mass resonance is converged to a preset target value, one of the first clock signal or the second clock signal is selected. The amplitude value and/or the phase value of the driving mass resonance is then detected by using both the selected one of the first and second clock signals and the first driving displacement signal (S100). Herein, the analog circuit 200 includes a charge amplifier 210, a driving displacement signal processing module 220, and a driving circuit module 230, which will be described below in detail.

The signal converter 300 converts the amplitude value and/or the phase value of the driving mass resonance, which are detected by the analog circuit 200, into a digital value (e.g., into 16 bits) (S110). The signal converter 300 may be an analog to digital (A/D) converter.

The digital automatic gain controller 400 selectively performs (based on decision block S120) an operation on a control gain (e.g., a 10 bit control gain) for controlling the amplitude or the phase of the vibration of the driving mass (S130) so that the amplitude value or the phase value of the driving mass resonance converted into the digital value by the signal converter 300 is converged to a targeted value (S120). The digital automatic grain controller 400 transmits the control gain to the analog circuit 200. The analog circuit 200 then applies the control gain to the driving signal, and the driving signal reflecting the control gain is applied to the gyro sensor 100 (S140).

Further, the digital automatic gain controller 400 receives from the analog circuit 200 a data for a signal having any one of the amplitude value and the phase value of the driving mass resonance depending on a preset rate coefficient. A data selection module 410 of the digital automatic gain controller 400 selects the signal data depending on the response speed of the driving mass to which the control gain for the amplitude or the phase is applied. The digital automatic gain controller 400 may further include a filter module 420 which removes noises of the amplitude value or the phase value of the driving mass resonance. Herein, the digital automatic gain controller 400 may include a data selection module 410, a filter module 420, a data processing control module 430, and a gain control module 440, which will be described below in detail.

As described above, according to the preferred embodiments of the present invention, the digital signal processing method using the digital automatic gain controller 400 and the A/D converter 300 controls the phase and amplitude of the driving mass resonance for the gyro sensor 100. The method reduces a size and current consumption of the overall driving circuit and improves the precision of the control as compared to previously used analog methods.

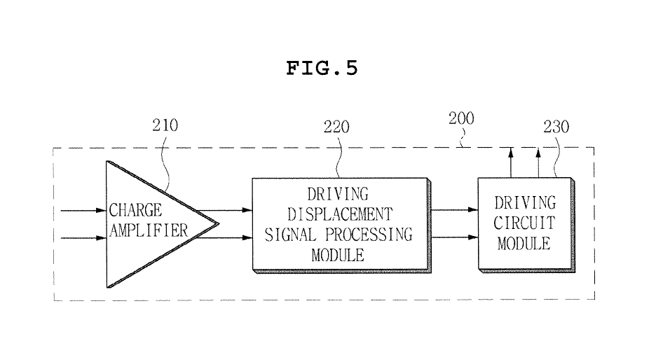

Hereinafter, the driving method of the analog circuit 200 according to the preferred embodiment of the present invention will be described in more detail with reference to FIGS. 5 to 7.

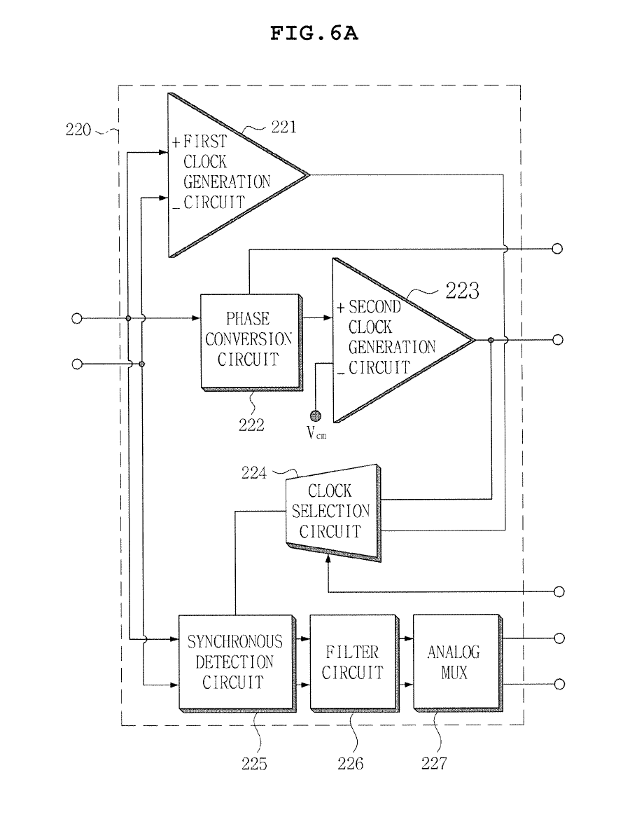

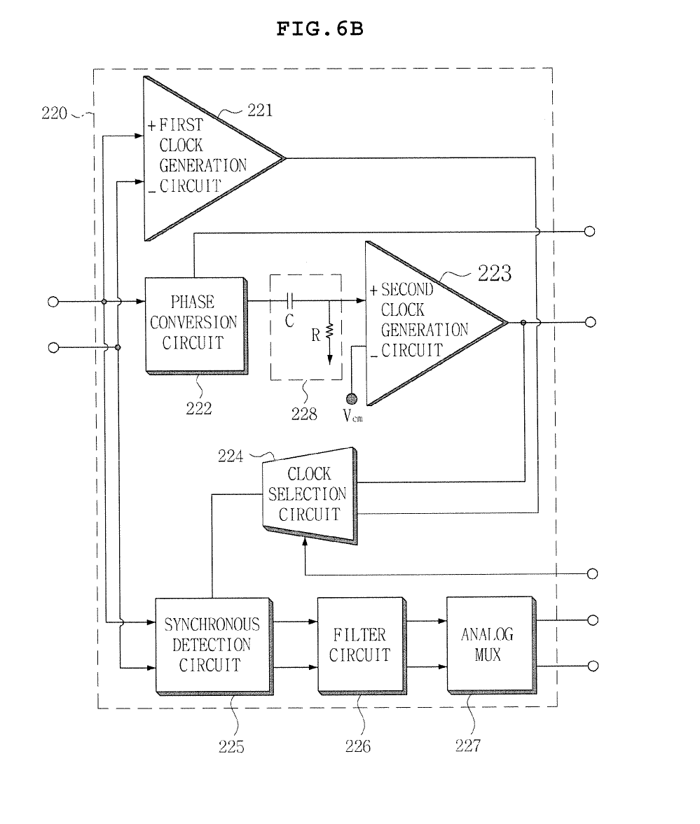

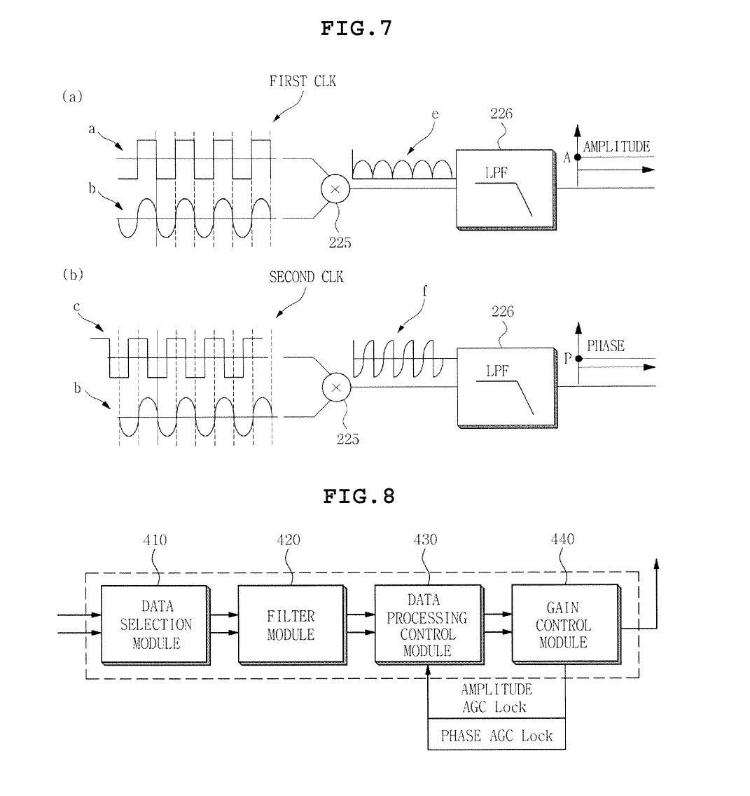

FIG. 5 is a block diagram illustrating a configuration of an analog circuit 200 according to an exemplary embodiment of the present invention, FIGS. 6A and 6B are block diagrams illustrating a configuration of a module for processing a driving displacement signal according to an exemplary embodiment of the present invention, and FIG. 7 is a diagram for explaining a process of detecting a phase and an amplitude value of driving mass resonance in the module for processing a driving displacement signal according to the exemplary embodiment of the present invention.

As illustrated in FIG. 5, the analog circuit 200 detects the amplitude value or the phase value of the driving mass resonance from the first and second driving displacement signals output from the gyro sensor 100. The analog circuit 200 may include the charge amplifier 210, the driving displacement signal processing module 220, and the driving circuit module 230.

The charge amplifier 210 converts a change in a charge amount generated in first and second driving displacement electrodes (not illustrated) of the gyro sensor 100 into a voltage signal, and then amplifies the voltage signal to output the first and second driving displacement signals.

The driving displacement signal processing module 220 uses the first and second driving displacement signals to generate the first and second clock signals. The driving displacement signal processing module 220 further detects the amplitude value or the phase value of the driving mass resonance by using the first driving displacement signal and using one of the first clock signal or the second clock signal. As illustrated in FIG. 6A, the driving displacement signal processing module 220 may include a first clock generation circuit 221, a phase conversion circuit 222 (e.g., operative to introduce a 90° phase), a second clock generation circuit 223, a clock selection circuit 224, a synchronous detection circuit 225, a filter circuit 226, and an analog multiplexer (Mux) 227. As illustrated in FIG. 6B, the driving displacement signal processing module 220 may further include an offset correction circuit 228 between the phase conversion circuit 222 and the second clock generation circuit 223.

The first clock generation circuit 221 uses the first and second driving displacement signals to generate a first clock signal a (see FIG. 7) that is phase-synchronized with the first driving displacement signal using a comparator. That is, the first and second driving displacement signals are respectively input to a non-inversion terminal and an inversion terminal of the comparator, and the first clock signal a (see FIG. 7) is generated at the output of the comparator by comparing the first and second driving displacement signals. Herein, the first clock signal a may be a square wave, but is not limited thereto.

The second clock generation circuit 223 uses a signal obtained by allowing the phase conversion circuit 222 to shift the phase of the first driving displacement signal by 90°. The second clock generation circuit 223 further uses a preset reference voltage V_{CM}, in conjunction with the signal obtained by allowing the phase conversion circuit 222 to shift the phase of the first driving displacement signal, to generate a second clock signal c (see FIG. 7) through the comparator. That is, the signal obtained by shifting the phase of the first driving displacement signal by 90° and the preset reference voltage V_{CM} are respectively input to the non-inversion terminal and the inversion terminal of the comparator, and the second clock signal c (see FIG. 7) is output by comparing the signal obtained by shifting the phase of the first driving displacement signal by 90° with the preset reference voltage V_{CM}. Herein, the second clock signal may be a square wave, but is not limited thereto.

Further, as illustrated in FIG. 6B, the driving displacement signal processing module 220 may additionally include the offset correction circuit 228 which is disposed between the phase conversion circuit 222 and the non-inversion terminal of the second clock generation circuit 223 to correct the DC offset which may be generated by the charge amplifier 210 (see FIG. 5) or the phase conversion circuit 222. The offset correction circuit 228 may be a high pass filter including a capacitor C and a resistor R, and values of the capacitor C and the resistor R may be determined so as to selectively set a cut-off frequency of the filter. Herein, the cut-off frequency may be set to be 200 Hz or less, but is not limited thereto.

That is, when DC offset is generated by the charge amplifier 210 (see FIG. 5) or by the phase conversion circuit 222, the offset correction circuit 228 removes the DC offset in real time so as to minimize the occurrence of errors in a duty ratio of the second clock signal c (see FIG. 7) generated by the second clock generation circuit 223, thereby securing the stability and accuracy of the overall control circuit.

The clock selection circuit 224 may select the first clock signal or the second clock signal depending on a selection signal received from the digital automatic gain controller 400. The digital automatic gain controller 400 provides the selection signal indicating whether the amplitude value or the phase value of the driving mass resonance is to be converged to a targeted value. The clock selection circuit 224 may be a digital or analog Mux such as the one described below in detail.

The synchronous detection circuit 225 detects the amplitude value or the phase value of the driving mass resonance by using a mixer to combine one of the first clock signal a or the second clock signal c (received from the clock selection circuit 224) and the first driving displacement signal. The filter circuit 226 may be a low pass filter used to detect the DC (or average, or steady-state) amplitude value or phase value of the driving mass resonance by removing noise from the amplitude value or the phase value of the driving mass resonance detected by the synchronous detection circuit 225.

That is, as illustrated in FIG. 7, 1) when the clock selection circuit 224 selects the first clock signal a, an amplitude signal e of the driving mass resonance is produced by using the mixer 225 to combine the first driving displacement signal b and the first clock signal a. The amplitude signal e is then filtered by a low pass filter (LPF) 226, and the amplitude value of the driving mass resonance is thereby converted into a constant voltage level A which has a high frequency component removed therefrom by the filter. Thereafter, the digital automatic gain controller 400 adjusts the control gain such that the amplitude of the driving mass resonance (represented by the voltage level A) converges to the preset targeted value.

2) When the second clock signal b is selected by the clock selection circuit 224, a phase signal f of the driving mass resonance may be produced by using the mixer 225 to combine the first driving displacement signal b and the second clock signal c. The phase signal f is then filtered by the LPF 226, and the phase value of the driving mass resonance is thereby converted into a constant voltage level P which has a high frequency component removed therefrom. Thereafter, the digital automatic gain controller 400 adjusts the control gain such that the phase of the driving mass resonance (represented by the voltage level P) converges to a value ‘0’.

The analog Mux 227 transmits the amplitude value or the phase value of the driving mass resonance to the digital automatic gain controller 400. That is, according to the structure shown in FIG. 3 using one A/D converter 300 to perform the digital signal processing on the phase value or the amplitude value of the driving mass resonance, it is possible to limit the size and current consumption of the overall circuit and reduce the size and current consumption of the circuit as compared to an equivalent circuit including multiple A/D converters (e.g., one for each detection module). The analog Mux 227 thus selects one of the phase value or the amplitude value for transmission to the A/D converter 300 and on to the digital automatic gain controller 400.

The driving circuit module 230 uses the second clock signal b (see, e.g., FIG. 7) generated by the second clock generation circuit 223 to generate the driving signal to be applied to the gyro sensor 100. The driving circuit module 230 may include a driving signal generation module 231 and a signal conversion circuit 232.

The signal conversion circuit 232 converts the control gain for the amplitude of the driving mass resonance that is received from the digital automatic gain controller 400 to determine the amplitude (e.g., voltage magnitude) of the driving signal to be applied to the gyro sensor 100. The driving signal generation module 231 uses the amplitude of the driving signal and the second clock signal c (see FIG. 7) to generate the driving signal that is applied to the gyro sensor 100.

Hereinafter, the driving method of the digital automatic gain controller 400 according to the preferred embodiment of the present invention will be described in more detail with reference to FIGS. 8 to 10.

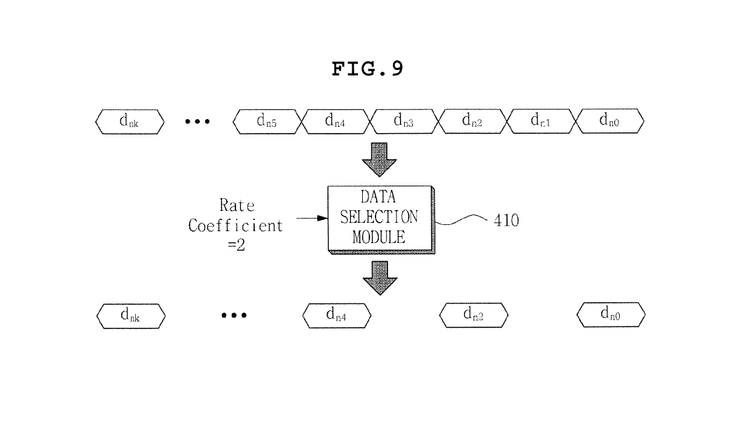

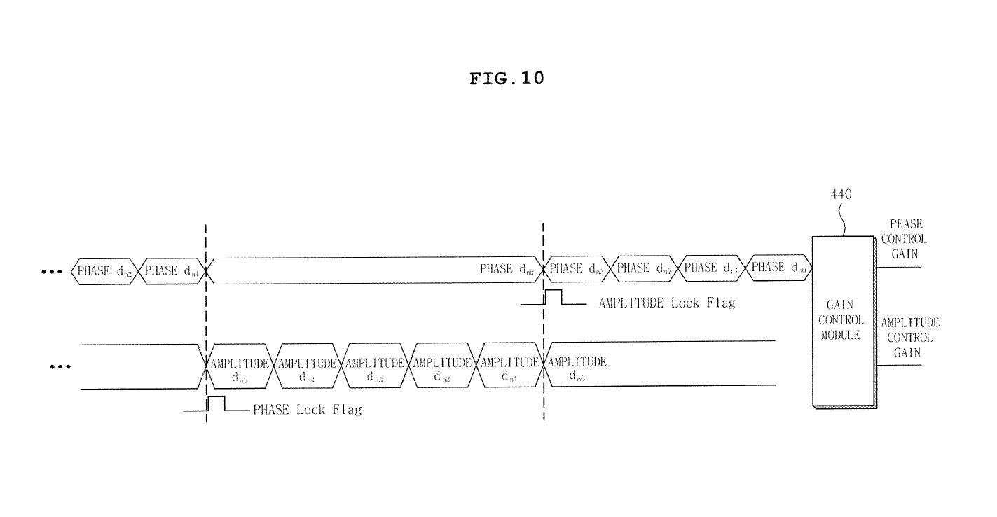

FIG. 8 is a block diagram illustrating a configuration of a digital automatic gain controller 400 according to an exemplary embodiment of the present invention, FIG. 9 is a diagram illustrating a data processing process taking place in a data selection module (e.g., 410) according to an exemplary embodiment of the present invention, and FIG. 10 is a diagram illustrating a data processing process taking place in a gain control module (e.g., 440) according to an exemplary embodiment of the present invention.

As illustrated in FIG. 8, the digital automatic gain controller 400 selectively performs an operation on the control gain of either the phase or the amplitude of the driving mass resonance. As such, either one of the amplitude value and the phase value (whichever is received from the signal converter 300) is first converged to the preset targeted value. The digital automatic gain controller 400 may include a data selection module 410, a filter module 420, a data processing control module 430, and a gain control module 440.

The data selection module 410 receives the data for the amplitude value or the phase value of the driving mass resonance from the signal converter 300, and selectively outputs the received data depending on a preset rate coefficient. The preset rate coefficient may be set in consideration of the response speed of the driving mass (not illustrated) to a change in the control gain applied by the gain control module 440.

That is, as illustrated in FIG. 9, when the rate coefficient is set to be 2, the data selection module 410 selectively outputs only every other packet or piece of data (e.g., corresponding to data having an index that is a multiple of 2, such as dₙ₁, dₙ₄, dₙ₆˜dₙₖ, among data dₙ₁ to dₙₖ) among the data for the amplitude value or the phase value of the driving mass resonance that is received from the analog circuit 200 through the signal converter 300.

Therefore, by selectively outputting only a subset of the data received by the data selection module 410, the data selection module 410 ensures that the control gain is not changed again before a prior adjustment to the control gain is applied to the driving mass. The operation of the data selection module 410 thereby prevents the overall system from oscillating, and/or prevents the driving mass from being physically damaged due abnormal motion of the driving mass caused by continuous adjustments to the control gain. Herein, the rate coefficient may be determined depending on the physical property of the driving mass of an inertial sensor, and in particular depending on the time taken by the driving mass to respond to a previous adjustment to the control gain.

The filter module 420 filters out any noise that is included in the phase value or the amplitude value of the driving mass resonance selected by the data selection module 410. The filter module 420 may be a digital low pass filter. That is, the phase value or the amplitude value transferred from the signal converter 300 to the filter module 420 by the data selection module 410 is low-pass filtered to produce a DC (or average, or steady-state) value. Hence, any noise introduced during the infoisnation processing process is removed.

The gain control module 440 compares the phase value or the amplitude value of the driving mass resonance received from the filter module 420, and determines whether the phase value or the amplitude value of the driving mass resonance filtered by the filter module 420 is converged to the preset targeted value. If it is determined that the phase value or the amplitude value of the driving mass resonance is not converged to the targeted value, the gain control module 440 performs an operation on the control gain for the phase or the amplitude of the driving mass resonance to cause the phase or the amplitude of the driving mass resonance to reach the targeted value.

That is, 1) in the case of the phase of the driving mass resonance, the gain control module 440 performs an operation on the control gain for the phase until the phase difference between the driving signal and the driving displacement signal maintains 90°, and 2) in the case of the amplitude of the driving mass resonance, the gain control module 440 performs an operation on the control gain for the amplitude so that the amplitude value is converged to the predetermined size. In both cases, the operation on the control gain is performed to make the driving mass resonate at a constant amplitude at all times. Herein, the gain control module 440 may be a proportional integral control (PID control) module.

The data processing control module 430 controls the gain control module 440 to perform the operation on the control gain so that any one of the amplitude and the phase is converged to the preset targeted value in a first phase of operation, and then the other (of the amplitude and the phase) is converged to the preset targeted value in a second phase of operation. In general, the preset targeted values to which the amplitude and the phase are converged are a preset amplitude targeted value and a preset phase targeted value that may be different values.

That is, as illustrated in FIG. 10, in the case of the operation state of the control gain of the phase control of the driving mass resonance, the gain control module 440 firstly performs the operation on the control gain of the phase control until the phase is converged to the preset targeted value. During this first phase or stage of operation, operations to control the amplitude are in a hold state. Once the phase is converted to the targeted value, a phase lock flag signal is transmitted to the data processing control module 430 to hold the current phase value.

Further, the data processing control module 430 receiving the phase lock flag signal transmits a low signal 0 as a select signal to the clock selection circuit 224. In response to the low select signal, the clock selection circuit 224 selects the first clock signal a (see FIG. 7) and transmits the first clock signal to the synchronous detection circuit 225. The synchronous detection circuit 225, having the first clock signal applied thereto, outputs the data for the amplitude value of the driving mass resonance. The data is converted in the filter circuit 226 into the constant voltage level A having the steady-state DC form, and the voltage level A is provided to the gain control module 440 through the data selection module 410. In turn, the gain control module 440 performs the operation on the control gain of the amplitude control until the amplitude of the driving mass resonance is converged to the preset targeted value (e.g., the preset targeted amplitude value). Further, when the amplitude of the driving mass is converged to the targeted value, the amplitude lock flag signal is transmitted to the data processing control module 430 to cause the data processing control module 430 to hold the amplitude value.

The data processing control module 430, in response to receiving the amplitude lock flag signal, transmits a high signal 1 as the select signal to the clock selection circuit 224. The clock selection circuit 224 then selects the second clock signal c (see FIG. 7), and transmits the second clock signal to the synchronous detection circuit 225. The synchronous detection circuit 225, having the second clock signal applied thereto, outputs the data for the phase value of the driving mass resonance. The data is converted in the filter circuit 226 into the constant voltage level P having the steady-state DC form, and the voltage level P is provided to the gain control module 440 through the data selection module 410. In turn, the gain control module 440 may perform the operation on the control gain of the phase control until the phase of the driving mass resonance is converged to the preset targeted value (e.g., the preset targeted phase value). By the process, the gain control module 440 sequentially performs the operations on the control gain of the phase and the amplitude of the driving mass resonance.

As described above, according to the apparatus for driving a gyro sensor according to the exemplary embodiment of the present invention, the clock selection circuit 224 and the data processing control module 430 may prevent the driving mass from being damaged due to the abnormal operation of the driving mass caused by simultaneously controlling the phase and amplitude of the driving mass resonance. Instead, by operation of the gain control module 430, the operations of adjusting the control gain for the amplitude and for the phase of the driving mass resonance are separately and sequentially performed, thereby securing the stability and accuracy of the overall control circuit.

The processing method, using the digital automatic gain controller 400 and the A/D converter 300, controls the phase and amplitude of the driving mass resonance for the gyro sensor 100, thereby reducing the size and current consumption of the overall control circuit and improving the precision of the control as compared to comparable analog methods.

Further, the data selection module 410 receives the data for the phase value or the amplitude value of the driving mass resonance and, in consideration of the speed at which the driving mass response to the control gain for the phase or amplitude of the driving mass resonance, selectively outputs a portion of the received data to the gain control module 440. The system thereby prevents damage to the driving mass or the oscillation of the overall system due to the application of a new control gain prior to performing the stabilization of the driving mass resonance based on the previously adjusted control gain.

In addition, the data processing control module 430 may prevent the driving mass from being damaged due to the abnormal operation of the driving mass caused by simultaneously controlling the phase and amplitude of the driving mass resonance. Specifically, by controlling the gain control module 440 to separately divide the operations of the control gain for the amplitude or for the phase of the driving mass resonance, and by sequentially performing the operations, the data processing control module 430 thereby ensures the stability and accuracy of the overall control circuit.

Moreover, the offset correction circuit 228 corrects any DC offset generated by the charge amplifier 210 (see FIG. 5) or by the phase conversion circuit 222 in real time so as to minimize the occurrence of errors in the duty ratio of the second clock signal c (see FIG. 7) generated by the second clock generation circuit 223. The offset correction circuit 228 thereby secures the stability and accuracy of the overall control circuit.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus for driving a gyro sensor, comprising:
a gyro sensor including at least one driving mass;
an analog circuit detecting an amplitude value or a phase value of resonance of the driving mass from first and second driving displacement signals output from the gyro sensor;
a signal converter converting the amplitude value or the phase value into a digital value; and
a digital automatic gain controller outputting a control gain for controlling a signal driving resonance of the driving mass based on a selected one of a phase or amplitude of the resonance of the driving mass, so that a selected one of the amplitude value and the phase value input from the signal converter is converged to a preset targeted value.

2. The apparatus as set forth in claim 1, wherein the digital automatic gain controller transmits the control gain for controlling the phase or the amplitude of the resonance of the driving mass to the analog circuit.

3. The apparatus as set forth in claim 1, wherein the analog circuit generates through a first comparator a first clock signal which is phase-synchronized with the first driving displacement signal and generates through a second comparator a second clock signal having a phase that is 90° earlier than a phase of the first driving displacement signal.

4. The apparatus as set forth in claim 3, wherein the analog circuit selects the first clock signal or the second clock signal depending on whether the amplitude value or the phase value of the driving mass resonance is to be converged to the preset targeted value.

5. The apparatus as set forth in claim 4, wherein the analog circuit detects the amplitude value of the resonance of the driving mass by mixing the first driving displacement signal with the first clock signal when the first clock signal is selected, and detects the phase value of the resonance of the driving mass by mixing the first driving displacement signal with the second clock signal when the second clock signal is selected.

6. The apparatus as set forth in claim 5, wherein the analog circuit includes a low pass filter (LPF) circuit which removes noise of the detected phase value or the detected amplitude value of the resonance of the driving mass.

7. The apparatus as set forth in claim 1, wherein the signal converter is an analog to digital converter.

8. The apparatus as set forth in claim 1, wherein the digital automatic gain controller receives a data signal including selected samples of one of the amplitude value and the phase value of the resonance of the driving mass from the analog circuit, wherein the samples are selected based on a preset rate coefficient that is determined according to a response speed of the amplitude or the phase of the driving mass to changes in the control gain.

9. The apparatus as set forth in claim 8, wherein the digital automatic gain controller includes a filter module which removes noise from the selected samples of the amplitude value or the phase value of the resonance of the driving mass.

10. The apparatus as set forth in claim 1, wherein the digital automatic gain controller generates a lock flag signal operative to cause a value of the control gain associated with the selected one of the amplitude value and the phase value being converged to the targeted value being held, and operative to cause an operation to be performed on the control gain to adjust the value of the other one of the amplitude value and the phase value.

11. The apparatus as set forth in claim 1, wherein the analog circuit includes:
a charge amplifier converting the signals output from the gyro sensor into voltage signals and amplifying and outputting the first and second driving displacement signals based on the signals output from the gyro sensor;
a driving displacement signal processing module generating a first clock signal which is phase-synchronized with the first driving displacement signal and a second clock signal having a phase that is 90° earlier than a phase of the first driving displacement signal by using the first and second driving displacement signals, and detecting the amplitude value or the phase value of the resonance of the to driving mass by mixing the first driving displacement signal with the first clock signal or the second clock signal; and
a driving circuit module using the second clock signal to generate a driving signal to be applied to the gyro sensor.

12. The apparatus as set forth in claim 11, wherein the driving displacement signal processing module includes:
a first clock generation circuit using a comparator and the first and second driving displacement signals to generate the first clock signal that is phase-synchronized with the first driving displacement signal;
a phase conversion circuit shifting the phase of the first driving displacement signal by 90°;
a second clock generation circuit using a comparator, a signal obtained by shifting the phase of the first driving displacement signal by 90°, and a preset reference voltage to generate the second clock signal;
a clock selection circuit selecting the first clock signal or the second clock signal depending on a selection signal received from the digital automatic gain controller;
a synchronous detection circuit detecting the amplitude value or the phase value of the resonance of the driving mass by mixing the first clock signal or the second clock signal with the first driving displacement signal;
a filter circuit filtering the detected amplitude value or phase value of the resonance of the driving mass by removing noise from the amplitude value or the phase value of the resonance of driving mass detected by the synchronous detection circuit; and
an analog multiplexer transmitting one of the filtered amplitude value and the filtered phase value of the resonance of the driving mass to the digital automatic gain controller.

13. The apparatus as set forth in claim 12, wherein the driving circuit module includes:
a signal conversion circuit converting the control gain for the amplitude of the driving mass resonance received from the digital automatic gain controller and used to determine an amplitude of the driving signal to be applied to the gyro sensor; and
a driving signal generation module using the amplitude of the driving signal and the second clock signal to generate the driving signal to be applied to the gyro sensor.

14. The apparatus as set forth in claim 13, wherein the digital automatic gain controller includes:
a data selection module receiving data for the amplitude value or the phase value of the resonance of the driving mass from the signal converter, and selectively outputting the received data depending on a rate coefficient set in consideration of a response speed of the driving mass to changes in the control gain applied to the driving mass;
a gain control module generating the control gain for the phase or the amplitude so that the amplitude value or the phase value of the resonance of the driving mass reaches the preset targeted value; and
a data processing control module controlling the gain control module so as to converge one of the amplitude and the phase of the resonance of the driving mass to the preset targeted value, and controlling the gain control module so as to converge another one of the amplitude and the phase of the resonance of the driving mass

15. The apparatus as set forth in claim 14, wherein the digital automatic gain controller further includes a filter which is disposed between the data selection module and the gain control module and removes noise from the amplitude value or the phase value of the resonance of the driving mass output by the data selection module.

16. The apparatus as set forth in claim 15, wherein the gain control module transmits to the data processing control module a lock flag signal operative to cause a value of the control gain associated with the selected one of the amplitude value and the phase value being converged to the targeted value to be held when any one of the phase and the amplitude of the driving mass resonance is converged to the preset targeted value.

17. The apparatus as set forth in claim 16, wherein in response to receiving the lock flag signal, the data processing control module controls the clock selection circuit to transmit only the data for the signal which is not converged to the preset targeted value in the phase or the amplitude of the driving mass resonance to the gain control module.

18. The apparatus as set forth in claim 17, wherein the data processing control module transmits a select signal to the clock selection circuit to cause the clock selection circuit to select a particular one of the first clock signal and the second clock signal.

19. A control method of an apparatus for driving a gyro sensor, comprising:
detecting, by an analog circuit, an amplitude value or a phase value of resonance of a driving mass of the gyro sensor from first and second driving displacement signals output from the gyro sensor;
converting, by a signal converter, the detected amplitude value or the detected phase value into a digital value; and
performing, by a digital automatic gain controller, an operation on a control gain for adjusting a phase or an amplitude of resonance of the driving mass so that one of the amplitude value and the phase value received from the signal converter converges to a preset targeted value.

20. The control method as set forth in claim 19, wherein the detecting, by the analog circuit, of the amplitude value or the phase value of resonance of the driving mass includes:
converting, by a charge amplifier, the signals output from the gyro sensor into voltage signals and amplifying the voltage signals to output the first and second driving displacement signals;
using, by a driving displacement signal processing module, the first and second driving displacement signals to generate first and second clock signals, and detecting the amplitude value or the phase value of resonance of the driving mass by mixing the first driving displacement signal and the first clock signal or the second clock signal; and
using, by a driving circuit module, the second clock signal to generate a driving signal to be applied to the gyro sensor.

21. The control method as set forth in claim 20, wherein the detecting, by the driving displacement signal processing module, of the amplitude value or the phase value of the driving mass resonance includes:
comparing, in a first clock generation circuit, the first and second driving displacement signals to generate the first clock signal that is phase-synchronized with the first driving displacement signal;
shifting, by a phase conversion circuit, a phase of the first driving displacement signal by 90′;
comparing, using a second clock generation circuit, a signal obtained by shifting the phase of the first driving displacement signal by 90° and a preset reference voltage to generate the second clock signal;
selecting, by a clock selection circuit, the first clock signal or the second clock signal depending on whether the amplitude value or the phase value of the driving mass resonance is converged to the preset targeted value in the digital automatic gain controller;
detecting, by a synchronous detection circuit, the amplitude value or the phase value of the driving mass resonance by mixing the first clock signal or the second clock signal with the first driving displacement signal;
filtering, by a low pass filter circuit, the amplitude value or the phase value of the driving mass resonance by removing noise from the amplitude value or the phase value of the driving mass resonance detected by the synchronous detection circuit; and
transmitting, by an analog multiplexer, the filtered amplitude value or the filtered phase value of the driving mass resonance to the digital automatic gain controller.

22. The control method as set forth in claim 21, wherein the generating, by the driving circuit module, of the driving signal includes:
converting, by a signal converter circuit, the control gain for the amplitude of the driving mass resonance that is received from the digital automatic gain controller to determine an amplitude of the driving signal to be applied to the gyro sensor; and
using, by a driving signal generation module, the converted amplitude of the driving signal and the second clock signal to generate the driving signal to be applied to the gyro sensor.

23. The control method as set forth in claim 22, wherein the performing, by the digital automatic gain controller, of the operation on the control gain for adjusting the phase or the amplitude of resonance of the driving mass includes:
outputting, by a data selection module, selected samples of data for the amplitude value or the phase value of resonance of the driving mass wherein the samples are selected depending on a preset rate coefficient that is set in consideration of a response speed of the driving mass to changes in control gain applied thereto;
performing, by a gain control module, the operation to generate the control gain for the phase or the amplitude so that the amplitude value or the phase value of resonance of the driving mass reaches the preset targeted value; and
controlling, by a data processing control module, the gain control module to converge one of the amplitude and the phase of resonance of the driving mass to the preset targeted value, and controlling the gain control module so as to converge another one of the amplitude and the phase of resonance of the driving mass.

24. The control method as set forth in claim 23, wherein the controlling, by a data processing control module, of the gain control module to perform the operation of the control gain for the amplitude and the phase of the driving mass resonance includes:
transmitting, by the gain control module to the data processing control module, a lock flag signal operative to cause a value of the control gain associated with the selected one of the amplitude value and the phase value being converged to the targeted value to be held when any one of the phase and the amplitude of the driving mass resonance is converged to the preset targeted value; and
controlling, by the data processing control module in response to receiving the lock flag signal, the clock selection circuit to transmit only the data for the signal which is not converged to the preset targeted value in the phase or the amplitude of the driving mass resonance to the gain control module.

25. The control method as set forth in claim 24, wherein the data processing control module transmits a select signal to the clock selection circuit to select any one of the first clock signal and the second clock signal.

26. A gyro sensor comprising:
a driving mass mounted in the gyro sensor so as to resonate in response to a driving signal; and
a controller configured to sense an amplitude and a phase of resonance of the driving mass, and to sequentially adjust during sequential time periods a gain controlling the driving signal applied to the driving mass based on the amplitude of resonance of the driving mass and a gain controlling the driving signal based on the phase of resonance of the driving mass.

27. The gyro sensor as set forth in claim 26, wherein the controller is configured to:
during a first time period, adjust the gain controlling the driving signal applied to the driving mass based on a first one of the amplitude and the phase of resonance of the driving mass so as to cause the first one of the amplitude and the phase of resonance of the driving mass to converge to a preset targeted value; and
upon determining that the first one of the amplitude and the phase of resonance of the driving mass is converged to the preset targeted value, adjust the gain controlling the driving signal applied to the driving mass based on another one of the amplitude and the phase of resonance of the driving mass during a second time period.

28. The gyro sensor as set forth in claim 27, wherein the controller includes:
an analog circuit producing amplitude value and phase value signals respectively indicative of the amplitude and the phase of resonance of the driving mass, wherein the analog circuit includes:
a charge amplifier sensing changes in charge amounts generated in first and second driving displacement electrodes of the gyro sensor, and outputting first and second driving displacement signals based on the sensed changes;
a driving displacement signal processing module generating, based on the first and second driving displacement signals, a first clock signal that is phase-synchronized with the first driving displacement signal and a second clock signal that is 90° out of phase with the first clock signal,
wherein the driving displacement signal processing module further generates an output signal that is indicative of the first one of the amplitude and the phase of resonance of the driving mass during the first time period and that is indicative of the other one of the amplitude and the phase of resonance of the driving mass during the second time period; and
a driving circuit module generating the driving signal applied to the driving mass so as to resonate the driving mass; and
a digital automatic gain controller receiving the output signal generated by the driving displacement signal processing module, and adjusting the gain controlling the driving signal applied by the driving circuit module to the driving mass based on the received output signal indicative of one of the amplitude and the phase of resonance of the driving mass.
